(19) United States
(12) Patent Application Publication
(10) Pub. No.: US 2026/0179181 A1
(43) Pub. Date: Jun. 25, 2026

(54) METHOD, APPARATUS, DEVICE, STORAGE MEDIUM AND PROGRAM PRODUCT FOR VISUAL GENERATION

(71) Applicants: Beijing Youzhuju Network Technology Co., Ltd., Beijing (CN); Lemon Inc., Grand Cayman (KY)

(72) Inventors: Shilong ZHANG, Beijing (CN); Shoufa Chen, Beijing (CN); Chongjian Ge, Beijing (CN); Yi Jiang, Los Angeles, CA (US); Zehuan Yuan, Beijing (CN); Bingyue Peng, Los Angeles, CA (US)

(21) Appl. No.: 19/308,042

(22) Filed: Aug. 22, 2025

(30) Foreign Application Priority Data
Dec. 23, 2024 (CN) 202411908176.7

(51) Int. Cl. G06T 3/4046

(52) U.S. Cl. CPC G06T 3/4046

(57) ABSTRACT

Embodiments of the disclosure provide a method, an apparatus, a device, a storage medium, and a program product for visual generation. The method includes: generating first visual content matching the text information at a first resolution by using a trained first content generation model and based on text information; performing up-sampling for the first visual content having the first resolution to obtain up-sampled first visual content having a second resolution, where the first resolution is lower than the second resolution; and generating second visual content matching the text information at the second resolution by using a trained second content generation model and based on the up-sampled first visual content and the text information.

### CROSS-REFERENCE

The present application claims priority to Chinese Patent Application No. 202411908176.7, filed on Dec. 23, 2024, and entitled “METHOD, APPARATUS, DEVICE, STORAGE MEDIUM AND PROGRAM PRODUCT FOR VISUAL GENERATION”, which is incorporated herein by reference in its entirety.

### FIELD

Example embodiments of the present disclosure generally relate to the field of computer technologies, and in particular, to a method, an apparatus, a device, a computer-readable storage medium, and a computer program product for visual generation.

### BACKGROUND

In the field of visual content generation, with the continuous advancement of technologies, generating images and videos based on text descriptions has become a research hotspot. With the continuous enrichment of application scenarios, users have put forward higher requirements for the quality and efficiency of generated visual content. Therefore, how to efficiently generate high-quality visual content has become a direction for continuous exploration in this field.

### SUMMARY

In a first aspect of the present disclosure, a method for visual generation is provided. The method includes: generating first visual content matching the text information at a first resolution by using a trained first content generation model and based on text information; performing up-sampling for the first visual content having the first resolution to obtain up-sampled first visual content having a second resolution, where the first resolution is lower than the second resolution; and generating second visual content matching the text information at the second resolution by using a trained second content generation model and based on the up-sampled first visual content and the text information.

In a second aspect of the present disclosure, an apparatus for visual generation is provided. The apparatus includes: a first generation module configured to generate first visual content matching the text information at a first resolution by using a trained first content generation model and based on text information; an up-sampling module configured to perform up-sampling for the first visual content having the first resolution to obtain up-sampled first visual content having a second resolution, where the first resolution is lower than the second resolution; and a second generation module configured to generate second visual content matching the text information at the second resolution by using a trained second content generation model and based on the up-sampled first visual content and the text information.

In a third aspect of the present disclosure, an electronic device is provided. The device includes at least one processor; and at least one memory, the at least one memory is coupled to the at least one processor and storing instructions executable by the at least one processor, the instructions, when executed by the at least one processor, causing the electronic device to perform the method of the first aspect.

In a fourth aspect of the present disclosure, a computer-readable storage medium is provided. The medium has a computer program stored thereon, the computer program, when executed by a processor, implementing the method of the first aspect.

In a fifth aspect of the present disclosure, a computer program product is provided. The computer program product includes a computer program, the computer program, when executed by a processor, implementing the method of the first aspect.

It should be understood that the content described in this section is neither intended to limit key or essential features of the embodiments of the present disclosure, nor is it intended to limit the scope of the present disclosure. Other features of the present disclosure will be readily envisaged through the following description.

### BRIEF DESCRIPTION OF THE DRAWINGS

The above and other features, advantages and aspects of the embodiments of the present disclosure will become more apparent in combination with the drawings and with reference to the following detailed description. In the drawings, the same or similar reference symbols refer to the same or similar elements, where:

FIG. 1 shows a schematic diagram of an example environment in which the embodiments of the present disclosure may be implemented;

FIG. 2 shows a schematic diagram of an example architecture for visual generation in an inference stage according to some embodiments of the present disclosure;

FIG. 3 shows a flowchart of a method for visual generation according to some embodiments of the present disclosure;

FIG. 4 shows an example structural block diagram of an apparatus for visual generation according to some embodiments of the present disclosure; and

FIG. 5 shows a block diagram of an electronic device in which one or more embodiments of the present disclosure may be implemented.

### DETAILED DESCRIPTION

Embodiments of the present disclosure will be described in more detail below with reference to the drawings. Although some embodiments of the present disclosure are shown in the drawings, it should be understood that the present disclosure may be implemented in various forms, and should not be construed as being limited to the embodiments set forth herein. Instead, these embodiments are provided for a more thorough and complete understanding of the present disclosure. It should be understood that the drawings and embodiments of the present disclosure are only for illustrative purposes, and are not intended to limit the protection scope of the present disclosure.

In the description of the embodiments of the present disclosure, the term “include/comprise” and similar terms should be understood as open-ended inclusions, that is, “include/comprise but not limited to”. The term “based on” should be understood as “at least partially based on”. The term “one embodiment” or “the embodiment” should be understood as “at least one embodiment”. The term “some embodiments” should be understood as “at least some embodiments”. The following may also include other explicit and implicit definitions.

It may be understood that the data involved in the technical solution (including but not limited to the data itself, acquisition or use of the data) should comply with requirements of corresponding laws, regulations, and related provisions.

It may be understood that before using the technical solutions disclosed in the embodiments of the present disclosure, the user should be informed of the type, range of use, use scenarios, etc., of personal information involved in the present disclosure in an appropriate manner and the authorization of the user should be obtained according to relevant laws and regulations.

For example, in response to receiving an active request from a user, prompt information is sent to the user to clearly prompt the user that the requested operation will require access to and use of the user's personal information, so that the user may independently choose whether to provide the personal information to software or hardware, such as an electronic device, an application, a server, or a storage medium, that performs the operations of the technical solutions of the present disclosure based on the prompt information.

As an optional but non-limiting implementation, in response to receiving the active request from the user, the prompt information may be sent to the user in the form of, for example, a pop-up window, in which the prompt information may be presented in text. In addition, the pop-up window may also include a selection control for the user to choose whether to “agree” or “disagree” to provide the personal information to the electronic device.

It may be understood that the above process of notifying and obtaining user authorization is only illustrative, and does not limit the implementations of the present disclosure. Other manners that satisfy the relevant laws and regulations may also be applied in the implementations of the present disclosure.

As used herein, a “model” may learn a correlation between corresponding inputs and outputs from training data, so that after the training is completed, a corresponding output may be generated for a given input. The model may be generated based on machine learning techniques. Deep learning is a machine learning algorithm that uses multiple layers of processing units to process inputs and provide corresponding outputs. A neural network model is an example of a model based on deep learning. Herein, a “model” may also be referred to as a “machine learning model”, a “learning model”, a “machine learning network”, or a “learning network”, which terms are used interchangeably herein.

A “neural network” is a machine learning network based on deep learning. A neural network may process an input and provide a corresponding output, and generally includes an input layer and an output layer, and one or more hidden layers between the input layer and the output layer. A neural network used in deep learning applications generally includes many hidden layers, thereby increasing the depth of the network. The layers of the neural network are connected in sequence, so that an output of a previous layer is provided as an input of a next layer, where the input layer receives the input of the neural network, and an output of the output layer serves as a final output of the neural network. Each layer of the neural network includes one or more nodes (also referred to as processing nodes or neurons), each processing an input from the previous layer.

Generally, machine learning may be broadly divided into three stages, namely a training stage, a testing stage, and an application stage (also referred to as an inference stage). In the training stage, a given model may be trained using a large amount of training data, and a parameter value may be continuously iteratively updated until the model may obtain consistent inference that satisfies an expected objective from the training data. Through training, the model may be considered to be capable of learning a correlation (also referred to as a mapping from an input to an output) from the input to the output from the training data. The parameter value of the trained model is determined. In the testing stage, a test input is applied to the trained model to test whether the model may provide a correct output, thereby determining the performance of the model. The testing stage may sometimes be incorporated into the training stage. In the application or inference stage, the trained model may be used to process an actual model input based on the parameter value obtained through training, to determine a corresponding model output.

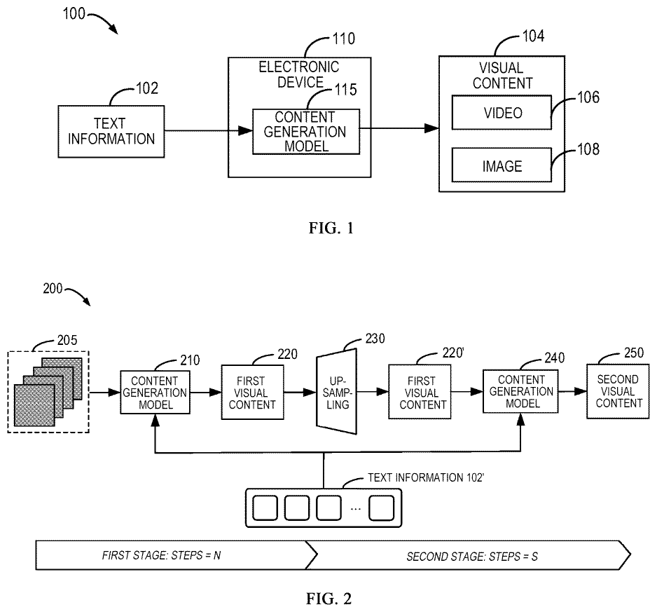

FIG. 1 shows a schematic diagram of an example environment 100 in which embodiments of the present disclosure may be implemented. As shown in FIG. 1, the environment 100 may include an electronic device 110. In the example environment 100, the electronic device 110 may obtain text information 102 related to visual content generation. The electronic device 110 may use a content generation model 115 to generate visual content 104 corresponding to the text information 102 based on the text information 102. The visual content 104 may include a video 106 and an image 108. As an example, the text information 102 may include information about a specified visual category, such as a generated video category or a generated image category.

The content generation model 115 may be a single model, or may be a combination of multiple models. As an example, the content generation model may be used to generate visual content matching the text information 102. The content generation model may be constructed using, for example, a diffusion model.

A diffusion model, also known as a diffusion probabilistic model, is a class of generative models. The model generates data by simulating a diffusion process. This process is inspired by physical processes (such as thermal diffusion). The diffusion model includes a forward diffusion process and a reverse diffusion process. The diffusion model simulates a forward diffusion process of gradually adding noise, and then learns how to reverse this process to generate new data samples.

In the forward diffusion process, noise is gradually added to the data, the data is made more and more random through a series of steps until the data resembles pure noise. This process may be viewed as a Markov chain, with each step adding Gaussian noise to the data. The forward diffusion process may be expressed as: q(xₜ|x^{t-1})= [symbol] (xₜ; \sqrt{αₜ}xₜ₋₁, (1−αₜ)I), where xₜ is the noise data at the t-th step, and αₜ is used to control the amount of noise added. The forward diffusion process is performed during model training, and the data to which noise is added is a training sample.

In the reverse diffusion process (or reverse denoising process), the model learns how to reverse the steps of adding noise. Starting from pure noise, the diffusion model gradually removes noise to generate data that matches the training distribution. The reverse diffusion process is typically simulated using a neural network that predicts the noise added at each step: p_{θ}(xₜ₋₁|xₜ)= [symbol] (xₜ₋₁; u_{θ}(xₜ, t), σ_{θ}(xₜ, t)), where u_{θ} and σ_{θ} are model parameters obtained through learning. After the model training is completed, the model performing the reverse diffusion process may first sample from a noise distribution, and perform iterative denoising using, until desired data is obtained.

In the diffusion model, a time step refers to the number of steps for adding noise in the forward diffusion process. The total number of steps T is usually a preset value, which represents how many steps are required for the transformation process from the original data to the pure noise. At each time step t, Gaussian noise is added to the data according to a predetermined noise scheme. This process is continuous, and each step depends on the result of the previous step.

When generating data, an inference step of the diffusion model refers to the number of steps required to restore from the pure noise to the original data in the reverse diffusion process. The number of inference steps directly affects the quality and speed of the generated data. Generally, the greater the number of inference steps, the higher the quality of the generated data. However, this also increases the computing cost and time. In practical applications, the number of inference steps may be adjusted to balance the quality and efficiency of generation. In some embodiments, the inference step corresponds to the time step, and each inference step may correspond to one or more time steps. For example, if the total number of time steps of the diffusion model is 1000, and the number of inference steps is set to 50, then each inference step may correspond to 20 time steps.

In the environment 100, the electronic device 110 may be any type of mobile terminal, fixed terminal, or portable terminal, including a mobile phone, a desktop computer, a laptop computer, a notebook computer, a netbook computer, a tablet computer, a media computer, a multimedia tablet, a personal communication system (PCS) device, a personal navigation device, a personal digital assistant (PDA), an audio/video player, a digital camera/video camera, a positioning device, a television receiver, a radio broadcast receiver, an e-book device, a gaming device, or any combination thereof, including accessories and peripherals of these devices, or any combination thereof. In some embodiments, the electronic device 110 may also support any type of user-specific interface (such as “wearable” circuitry, etc.). The content generation model 105 may, for example, be implemented on various types of computing systems/servers that may provide computing power, including but not limited to mainframes, edge computing nodes, computing devices in cloud environments, and the like.

It should be understood that the structures and functions of the elements in the environment 100 are described for illustrative purposes only, without suggesting any limitation to the scope of the present disclosure.

At present, the technology of generating visual content (for example, including videos, images, dynamic pictures, etc.) from text is developing rapidly, mainly driven by a new generation of paradigms, and more extensible model architectures and extended model parameters, as well as datasets of text and video pairs. Among these different generation paradigms and model architectures, a diffusion/flow-matching paradigm coupling and a DiT technology are more prominent. This combination has an advantage in its continuous performance enhancement commensurate with growing model parameters and dataset sizes.

However, the inference cost associated with this paradigm is very high. First, diffusion/flow-based models require iterative refinement to produce high-quality results. It has been observed that reducing the number of inference steps for video generation is more challenging than for image generation, which is attributed to an increased dimensionality of time. A reduction in the number of steps may adversely affect quality and text prompt alignment performance. Therefore, it is common for current approaches to adopt the number of steps for inference as 50, i.e., Step=50. On the other hand, adopting a 3D full attention mechanism across time (T), height (H), and width (W) leads to a computational cost of (T×H×W)². This means that as the video resolution increases, the computational cost increases sharply. The overall computational cost for inferring a video latent feature having a shape of (T, H, W) is on the order of O ((T×H×W)²×Step).

Through analysis, it is found that such an architecture has challenges in generating high-resolution videos. Here, an in-depth analysis is performed on how the inference time steps and resolution (H×W) affect the quality of the generated video. For the number of inference steps, it is concluded that reducing the number of inference steps for video generation is more challenging than for image generation, which may be due to the increased time dimension. A reduction in the number of time steps may severely affect the generation quality and text prompt alignment performance. Meanwhile, the resolution (H×W) is closely related to the ability to generate details (such as fine textures). When generating fine-grained visual content (such as a tiny face or hand), reducing the resolution may also make the model prone to defects.

For current work exploring cascaded architectures in the text-to-image domain, most of it is motivated by the fact that generating high-resolution images in a single stage is challenging and inefficient. A cascaded model encapsulates a series of independently trained models operating at different resolutions. Such a pipeline starts from generating low-resolution samples, and then introduces super-resolution style models whose objective is to boost these low-resolution samples into more visually appealing high-resolution ones. However, the diffusion formulation makes the super-resolution style also have to start sampling from pure noise and condition on the low-resolution output. Although it is also possible to have the second stage start from the first stage distribution within the diffusion theory, both theory and implementation are complicated and do not guarantee an optimal transport. In addition, a super-resolution stage for text-to-image flow matching is proposed, but is limited prior to model training, which makes it difficult to improve the quality of the video generated in the first stage.

To at least partially solve the above problems, an embodiment of the present disclosure proposes a solution for visual generation. In this solution, a trained first content generation model is used to generate, based on text information and at a first resolution, first visual content matching the text information. The first visual content having the first resolution is up-sampled to obtain up-sampled first visual content having a second resolution, where the first resolution is lower than the second resolution. Then, a trained second content generation model is used to generate, based on the up-sampled first visual content and the text information and at the second resolution, second visual content matching the text information.

According to the solution of the present disclosure, with a cascaded model including the first content generation model and the second content generation model and a two-stage visual generation architecture, the speed and efficiency of visual content generation may be improved, and high-resolution visual content may be generated. In addition, the inference cost of high-resolution visual content generation may be greatly reduced.

Some example embodiments of the present disclosure will be further described below with reference to the drawings.

FIG. 2 shows a schematic diagram of an example architecture 200 for visual generation in an inference stage according to some embodiments of the present disclosure. For ease of discussion, these embodiments will be described with reference to the environment 100 of FIG. 1. These embodiments may be implemented in the electronic device 110 of FIG. 1. The architecture 200 may be implemented in the environment 100 of FIG. 1. The architecture 200 shows two stages for visual generation in the inference stage, including a first stage and a second stage. The inference processes of the first stage and the second stage will be discussed in detail below.

As shown in FIG. 2, the electronic device 110 uses a trained content generation model 210 to generate, based on text information 102′ and at a first resolution, first visual content 220 matching the text information 102′. Accordingly, the generated first visual content 220 has the first resolution. Such a process may be referred to as a first-stage inference process. Here, the first visual content 220 may include a first image or a first video. Accordingly, the first image or the first video is an image or a video having the first resolution, respectively.

In some embodiments, the content generation model 210 may be constructed based on a first diffusion model. The diffusion model is a machine learning model with text-to-image generation capability, which may generate a corresponding image or video frame based on a text description. In addition, in the inference stage, the diffusion model may iterate from noise 205 (such as Gaussian noise). It should be understood that in other embodiments, the content generation model 210 may alternatively be constructed based on other machine learning models with text-to-image generation capability. The training process of the content generation model 210 will be discussed in detail below.

In some embodiments, the text information 102′ may be input to the content generation model 210 to guide the content generation model 210 to generate the first image or the first video matching a semantics of the text information 102′. For example, assuming that the text information 102′ is “Please generate an image of a rabbit eating a carrot”, an image about “a rabbit eating a carrot” may be generated by the trained content generation model 210 based on the text information.

In some embodiments, the first resolution may be a resolution that is reduced in the first stage based on an original resolution (H×W). The reduction ratio may be set to a reasonable ratio according to the actual situation. For example, the resolution (H×W) may be reduced to ((H/4)×(W/4)), or to other suitable ratios. In the first stage, some visual quality is sacrificed, but enough inference steps are retained to ensure text fidelity and smooth motion.

The inference process of the second stage will be discussed in detail below.

Further, the electronic device 110 up-samples (230) the first visual content 220 having the first resolution to obtain up-sampled first visual content 220′ having the second resolution. The first resolution is lower than the second resolution.

Here, up-sampling may be used to increase the resolution of an image or a video. That is, a low-resolution image may be generated into a high-resolution image through up-sampling, or a low-resolution video may be converted into a high-resolution video. Accordingly, the second resolution of the first visual content 220′ obtained after up-sampling the first visual content 220 is higher than the first resolution of the first visual content 220.

Further, the electronic device 110 uses a trained content generation model 240 to generate, based on the up-sampled first visual content 220′ and the text information 102′ and at the second resolution, second visual content 250 matching the text information 102′. Accordingly, the generated second visual content 250 has the second resolution. Here, the second visual content 250 may include a second image or a second video. Accordingly, the second image or the second video is an image or a video having the second resolution, respectively. The training process of the content generation model 240 will be discussed in detail below.

In this way, based on the text information 102′, the first visual content 220 having the first resolution is generated by the first-stage content generation model 210, and then the second visual content 250 having the second resolution higher than the first resolution is generated through the second-stage up-sampling process 230 and the content generation model 240. In this way, the second visual content 250 having a high resolution is obtained based on the text information 102′ through the first stage and the second stage.

It should be understood that the high and low resolutions discussed herein are relative, and no limitation is imposed on the specific size of the resolution. For example, where 1920×1080 may be a high resolution, 720×576 may be a low resolution, which is not intended to be any limitation.

For example, still assuming that the text information 102′ is “Please generate an image of a rabbit eating a carrot”, a low-resolution image about “a rabbit eating a carrot” may be generated through the first stage based on the text information. Then, a high-resolution image about “a rabbit eating a carrot” may be generated through the second stage.

In some embodiments, the content generation model 240 may be constructed based on a second diffusion model. As discussed above, the diffusion model is a machine learning model with text-to-image generation capability, which may generate a corresponding image or video frame based on a text description.

It should be understood that in other embodiments, the content generation model 240 may alternatively be constructed based on other machine learning models with text-to-image generation capability. The training process of the content generation model 240 will be discussed in detail below.

The two-stage video generation architecture in the embodiments of the present disclosure is novel and efficient, and may reduce the resolution in the first stage while maintaining a sufficient number of inference steps. This may ensure the fidelity of the generated visual content and the smoothness of video motion.

Through this paradigm, more videos or images may be generated in a shorter time, which greatly reduces the inference time and the total floating-point operations. Therefore, the architecture for visual generation in the embodiments of the present disclosure has significant advantages in terms of efficiency and visual quality.

With the architecture of the embodiments of the present disclosure, a cascaded model including the first content generation model and the second content generation model is implemented, which provides an ingenious design for the resolution and inference step at different stages, and greatly reduces the inference cost of high-resolution video generation.

In some embodiments, the first visual content 220 may be a first video, and the second visual content 250 may be a second video. When generating the first visual content 220, the electronic device 110 may use the content generation model 210 to generate the first video based on the text information 102′, at the first resolution and at a first frame rate. Accordingly, when generating the second visual content 250, the electronic device 110 may use the second content generation model to generate the second video based on the up-sampled first video and the text information 102′, at the second resolution and at a second frame rate. The first frame rate is lower than the second frame rate.

In such embodiments, for visual content such as a video, when implementing visual generation, in addition to processing the resolution, it is also possible to consider processing the frame rate. Specifically, the frame rate may also be reduced in the first stage, and then increased in the second stage. If the first visual content 220 is an image, then only a reduction in the resolution (that is, the resolution output by the first model is lower than the predetermined second resolution) may be considered. If the first visual content 220 is a video, then a reduction in the resolution (H×W) may be considered, and it may also be possible to reduce the frame rate (T).

In this way, based on the text information 102′, after the first visual content 220 having the first resolution and the first frame rate is generated by the first-stage content generation model 210, the second visual content 250 having the second resolution higher than the first resolution and the second frame rate greater than the first frame rate is generated through the second-stage up-sampling process 230 and the content generation model 240. In this way, the second visual content 250 having a high resolution and a high frame rate is obtained based on the text information 102′ through the first stage and the second stage.

It should be understood that the large and small frame rates discussed herein are relative, and no limitation is imposed on the specific value of the resolution.

For example, assuming that the text information 102′ is “Please generate a video of a rabbit eating a carrot”, a video of “a rabbit eating a carrot” with a low resolution and a low frame rate may be generated through the first stage based on the text information. Then, a video of “a rabbit eating a carrot” with a high resolution and a high frame rate may be generated through the second stage.

In some embodiments, when generating the second visual content, the electronic device 110 may iteratively perform a plurality of inference steps of the content generation model 240. The plurality of inference steps (S inference steps) may, for example, be represented as [0, 1, . . . , S−1]. Each of the plurality of inference steps may perform the steps of the following embodiments at each iteration.

Processing for a given inference step s (a value range thereof is [0, 1, . . . , S−1]) in the plurality of inference steps may include:

Differential visual content is generated by using the content generation model 240 and based on input visual content for the given inference step s, the text information, and a weighting parameter for the given inference step. The input visual content is initialized to the up-sampled first visual content in the plurality of inference steps. The differential visual content may, for example, be represented as Δ_{z}, the weighting parameter is represented as t, and Δ_{z}≙F_{θ}‘(Ź, t)*Δₜ, F_{θ} may represent the content generation model 240 having a parameter θ,

$${Δ}_{t} = \frac{1}{S} .$$

A value range of the weighting parameter t is between 0 to 1. The weighting parameter t continuously changes from 0 to 1 with a specific inference step. Specifically, t is initialized to 0 when s=0, and t is equal to 1 when s=S−1 (that is, the last inference step).

Further, predicted visual content for the given inference step may be determined based on a combination of the differential visual content Δ_{z} and the input visual content for the given inference step s. The predicted visual content may be represented as Z, and Z≅Z+Δ_{z}. In the 0th inference step, the initial predicted visual content is represented as Z=Z_{LQ}, and Z_{LQ} may represent a visual feature representation corresponding to the low-quality input visual content X_{LQ} of the content generation model 240, which is represented as Z_{LQ}=DEGₗₐₜₑₙₜ(ε(X_{LQ}))), where ε represents a visual encoder configured to extract the visual feature representation. As the number of inference steps increases, the predicted visual content continuously accumulates the differential visual content Δ_{z} generated at each inference step, to obtain updated predicted visual content.

Then, the predicted visual content Z for the given inference step may be determined as input visual content for a next inference step s+1. Next, the weighting parameter t may be updated to obtain the input visual content for the next inference step s+1. The update of the weighting parameter t may be represented as t=t+Δₜ, that is, t=t+1/S; that is, the weighting parameter t increases as the number of inference steps increases.

The foregoing operations for the given inference step may be iteratively performed until the S inference steps are completed. Further, the electronic device 110 may obtain predicted visual content obtained after inference in the plurality of inference steps, as the second visual content having the second resolution. Specifically, the predicted visual content obtained at the (S−1)-th inference step is represented as Z_{HQ}=Z (that is, an output of the (S−1)-th inference step), which is a feature representation of visual content. The second visual content is obtained by decoding the visual feature representation using a visual decoder model, and is identified as X_{HQ}=D(Z_{HQ}), where D represents a visual decoder.

In this way, the content generation model 240 iteratively generates the final visual generation content, that is, the second visual content X_{HQ}, in the plurality of inference steps.

In the second stage of the embodiments of the present disclosure, a good transport between low-quality and high-quality videos is established through flow-matching, to incorporate a large amount of visual details at high resolution but with fewer inference steps. In addition, the warping and deformation of frames at high resolution are fixed. In this way, high-quality high-resolution video or image generation is efficiently achieved at a low computational cost.

The training processes of the content generation model 210 and the content generation model 240 will be discussed in detail below. As mentioned above, in the embodiments of the present disclosure, the content generation model 210 is to be trained to be capable of generating, based on the text information 102′, the matched first visual content 220 having the first resolution. The content generation model 240 is to be trained to be capable of generating, based on the text information 102′ and the up-sampled first visual content 220′, the second visual content 250 having the second resolution.

In some embodiments, the content generation model 210 may be trained based on a plurality of sample texts and a plurality of sample videos having the first resolution. The plurality of sample texts and the corresponding plurality of sample videos having the first resolution may be included in a training dataset of the content generation model 210. The plurality of sample videos may also be referred to as a plurality of ground-truth videos.

During training, the content generation model 210 may output a plurality of predicted videos having the first resolution based on the plurality of sample texts. A training objective of the content generation model 210 is to make the plurality of predicted videos as close as possible to the plurality of sample videos. A corresponding training loss may be defined based on differences between the plurality of predicted videos and the plurality of sample videos. The training loss may be represented as any appropriate loss function that may determine the differences between the plurality of predicted videos and the plurality of sample videos. The differences between the plurality of predicted videos and the plurality of sample videos may be minimized or reduced to meet a corresponding predetermined objective, to train the content generation model 210.

In some embodiments, a motion score of a first sample video in the plurality of sample videos is lower than a predetermined motion threshold. A sample text corresponding to the first sample video includes a motion indicator and a text description of the first sample video, the motion indicator indicating that the first sample video is a low-motion video.

In the training process of the content generation model 210, a motion score of each sample video is determined. The motion score of the video may be an indicator for quantitatively evaluating a motion situation of some elements in the video or an overall motion characteristic of the video. The motion score may be used, for example, to determine smoothness, coordination, speed and rhythm, stability, etc., of the motion of some elements in the video. As an example, a RAFT (Recurrent All-Pairs Field Transforms) may be used to calculate an optical flow of a video clip to generate a motion score representing a motion intensity.

Since most videos show a limited degree of motion during the inference process, the following embodiments may be used to solve this problem in a simple and effective manner. In some embodiments, during the training process, among all sample videos with motion scores lower than the predetermined motion threshold (for example, <1), some sample videos are selected with a certain probability (for example, a probability of 2% or other probabilities), and a motion indicator is added to the sample text corresponding to the selected sample video. The motion indicator may be, for example, “low motion video”, or any other suitable motion indicator that may indicate a low motion score of the video.

In the inference stage, the motion indicator may be added to a reverse prompt. Therefore, when the content generation model 210 is guided to generate a video, generation of video content whose motion degree does not meet a requirement may be avoided, so that the generated video may meet an expected motion feature.

By selecting a sample with a certain probability based on the motion score of the sample video in the training process of the first content generation model, and adding the motion indicator to the sample text corresponding to the sample video, the motion intensity of the generated video may be significantly improved.

In some embodiments, the content generation model 240 may be trained based on a plurality of sample pairs. Each sample pair may include first sample visual content having the first resolution and second sample visual content having the second resolution. The first sample visual content may include a first sample image and a first sample video. The second sample visual content may include a second sample image and a second sample video. To implement joint training, the sample visual content includes both the sample video and the sample image. The joint training process will be discussed in detail below.

An MMDiT architecture may be used to ensure the consistency of enhanced visual content details and fix the warping and deformation of frames in the visual content. In addition, a 3D RoPE (Rotary Position Encoding) may also be used in this architecture to replace the original position frequency embedding representation. This is because the RoPE may help the model obtain better resolution scalability when being trained and performing inference at different resolutions. The language embedding representation of the first stage is directly used as a condition of this stage without an additional text encoding process. Here, an important training design is introduced to achieve an optimal transport from a low-quality video (which may be represented as X_{LQ}) to a high-quality video (which may be represented as X_{HQ}).

$${x}_{t} = ( 1 - t ) \cdot {x}_{LQ} + t \cdot {x}_{HQ} , t ∈ [ 0 , 1 ] \qquad ( 1 )$$

As shown in formula (1), an optimal transport (OT) displacement interpolation may be used to define a conditional probability path between X_{LQ}) and X_{HQ}. The path starts from X_{LQ} when t=0, and reaches X_{HQ} when t=1.

In some embodiments, the first sample visual content may be generated by: the electronic device 110 may perform a pixel space down-grading operation on the second sample visual content to obtain second down-graded sample visual content having the first resolution. The pixel space down-grading operation includes at least a size compression operation and a blurring operation. Then, the electronic device 110 may apply a noise signal to the second down-graded sample visual content having the first resolution, to obtain the first sample visual content.

As an example, the pixel space down-grading operation may be implemented using a pixel space degradation function. In other examples, the pixel space down-grading operation may alternatively be implemented using other functions or manners that may degrade the pixel space. As an example, the blurring operation may be based on a Gaussian function or other suitable functions or manners to blur the second sample visual content. The size compression operation may be used to compress a size of the second sample visual content. The noise signal may be, for example, Gaussian noise, or may be any other appropriate noise that may degrade the visual content.

To obtain a low-quality video (which may be represented as X_{LQ}), a high-resolution video may be started with, and an appropriate degradation process may be introduced. The low-quality video generated in the initial stage presents two main characteristics: lack of texture details, and warping and deformation of visual content. To remove texture details in a high-quality video (which may be represented as X_{HQ}), a pixel space degradation function may be applied through blurring and resizing operations. This function has a random intensity in each execution. However, the warping and deformation of frames are difficult to simulate through pixel space transformations, since they usually appear as areas with wrong pixels. The occurrence of warping and deformation of frames may be attributed to errors in the potential output of the first stage model, which is caused by calculations in a low-resolution latent space.

Therefore, the video may first be encoded into a latent space with pixel-space degradation. Then, the encoded video is mixed with Gaussian noise with coefficients of a and 1-a, respectively. This process uses a video with warping and deformation of frames as input. These warped and deformed frames come from incorrect latent space positions that deviate, allowing the second stage model to correct errors in a larger latent resolution space.

$${x}_{L Q} = α \cdot PSD ( {x}_{HQ} ) - β \cdot N ( 0 , 1 ) , α ∈ [ 0 , 1 ] , {α}^{2} + {β}^{2} = 1 \qquad ( 2 )$$

where PSD may represent the pixel space degradation function, N may represent the Gaussian noise, and α and β may respectively represent a coefficient of the pixel space degradation function and a coefficient of the Gaussian noise.

The entire process is shown in formula (2). By applying degradation techniques in the pixel and latent space to the second sample visual content, the input of the initial low-quality first sample visual content in the second stage is simulated. This process processes the input video with videos at different latent space positions, allowing errors to be corrected in the second stage model to adapt to a larger latent resolution space. In addition, in order to enable the model to perceive different noise intensities, a sine function with a linear layer may be used to encode them as embedding representations, which are then added to the time embedding representation of the MMDiT.

In some embodiments, when applying the noise signal to the second down-graded sample visual content having the first resolution to obtain the first sample visual content, the electronic device 110 may encode the second down-graded sample visual content into a visual feature representation. Then, the electronic device 110 may obtain a noise-added visual content feature representation by applying the noise signal to the visual feature representation. Next, the noise-added visual feature representation may be decoded to generate the first sample visual content.

In such embodiments, the video may first be encoded into the latent space with pixel space degradation, to obtain a vector representation in the latent space, that is, the visual feature representation. Then, the encoded video may be mixed with Gaussian noise (or other noise signals) with coefficients of α and 1−α (or β), respectively, to obtain the noise-added visual content feature representation. Then, the noise-added visual content feature representation is correspondingly decoded to obtain the low-quality first sample visual content.

As an example, a visual encoder, such as a VAE encoder, or other suitable visual encoders may be used to encode the video. At this time, the video that has been subjected to the pixel space degradation processing is encoded into the latent space, and the encoded video may be represented as Z, and Z=ε(DEGₚᵢₓₑₗ(X_{HQ}). Correspondingly, a visual decoder, such as a VAE decoder, or other suitable visual decoders corresponding to the visual encoder may be used to decode the video.

In this way, by using the high-quality second sample visual content to simulate the low-quality first sample visual content, and using flow-matching to achieve an optimal transport between the low-quality and high-quality videos, it is possible to correct the warping and deformation of frames in a few steps (for example, 4 steps or other short steps), and a large amount of visual texture details may be incorporated. This helps to efficiently achieve high-resolution, high-quality video or image generation at low cost.

In some embodiments, the content generation model 240 may be trained by: the electronic device 110 may obtain a sample pair including first sample visual content having the first resolution and second sample visual content having the second resolution. As an example, a high-quality sample (which may be represented as X_{HQ}) may be sampled from a dataset (which may be represented as D_{HQ}) including a large number of high-quality images and videos. Then, after the pixel space down-grading operation is performed on the high-quality sample, the first sample visual content may be obtained. The first sample visual content having the first resolution is generated from the second sample content X_{HQ}, and a feature representation corresponding to the first sample visual content may be represented as Z_{LQ}, and Z_{LQ}=DEGₗₐₜₑₙₜ(ε(DEGₚᵢₓₑₗ(X_{HQ}) where ε represents a visual encoder configured to extract the visual feature representation. Correspondingly, a feature representation corresponding to the second sample visual content X_{HQ} having the second resolution may be represented as Z_{HQ}, and Z_{HQ}=ε(X_{HQ}).

Further, the electronic device 110 may determine differential visual content between the second sample visual content and the first sample visual content. The differential visual content may be represented as Target. In some embodiments, the differential visual content may be represented as a difference between the second sample visual content and the feature representation of the first sample visual content, and is represented as Tařget=Z_{HQ}−\grave{Z}_{L\grave{Q}}.

As mentioned above, the content generation model 240 iteratively performs a plurality of inference steps. The model input at each inference step is represented as input, and each inference step also corresponds to a weighting parameter t. As described above, the weighting parameter t is initialized to 0, and continuously increases with the inference step until t=1 at the last inference step. For a given inference step s in the plurality of inference steps, a first weight for the first sample visual content and a second weight for the second sample visual content may be determined. During the training process, a time step t may be randomly sampled from a uniform distribution of [0, 1]. Then, the first weight of the first sample visual content may be represented as (1-t), and the second weight may be represented as (t). Next, the first sample visual content and the second sample visual content may be weighted and aggregated based on the first weight and the second weight, respectively, to obtain the input visual content for the given inference step s. The input visual content may be determined in a feature space of the first sample visual content and the second sample visual content, that is, Input≙(1−t)·Z_{LQ}+t·Z_{HQ}.

Then, the predicted visual content for the given inference step s is determined using the content generation model 240 being trained, based on the input visual content. The predicted visual content determined by the model may be represented as F_{θ} (Input, t) where θ may represent a model parameter of the content generation model 240.

Further, the electronic device 110 may update the content generation model 240 based on a difference between the differential visual content Target and the predicted visual content F_{θ} (Input, t) determined by the model. The difference between the differential visual content and the predicted visual content may be represented as ∇_{θ}∥Target−F_{θ} (I\ddot{n}put, t)∥². In some embodiments, gradient descent may be calculated based on the difference between the differential visual content and the predicted visual content, and the model parameter of the second content generation model may be updated through a gradient backpropagation algorithm. The gradient descent may be calculated and the gradient may be backpropagated in any appropriate manner applicable to model training applications, which is not limited in the embodiments of the present disclosure.

In such embodiments, the foregoing steps may be iteratively performed for each inference step of the content generation model 240 until a convergence condition of model training is reached. The convergence condition may be configured as required.

In some embodiments, in the second stage, joint training may be performed on videos and images. The sample pair for training the content generation model 240 may be a mixed sample of images and videos. Specifically, the plurality of sample pairs include a first sample pair and a second sample pair, the first sample pair includes a first sample image having the first resolution and a second sample image having the second resolution, and the second sample pair includes a first sample video having the first resolution and a second sample video having the second resolution. This is because for many high-quality videos, there are still significant differences on a picture paper in their single frames, especially in terms of texture clarity. To alleviate this problem, a large number of high-quality images may also be used for training. In addition, compared with high-quality videos, more high-quality images may usually be collected. Therefore, training the second content generation model by combining a large number of high-quality images helps to improve the final quality of the generated video and improve the texture details of the video.

Specifically, during training, the content generation model 240 may output a predicted image having the second resolution based on the first sample image having the first resolution, and may also output a predicted video having the second resolution based on the first sample video having the first resolution. A training objective of the content generation model 240 is to make the predicted image and video having the second resolution as close as possible to a respective corresponding sample image and sample video having the first resolution. Differences between the predicted image having the second resolution and the sample image having the first resolution may be minimized or reduced to meet a corresponding predetermined objective, and differences between the predicted video having the second resolution and the sample video having the first resolution may be minimized or reduced to meet a corresponding predetermined objective, to train the content generation model 240.

Through the training process of the embodiments of the present disclosure, a large amount of visual details are incorporated at high resolution, and the warping and deformation of frames at high resolution are fixed. This facilitates the generation of high-resolution, high-quality videos or images.

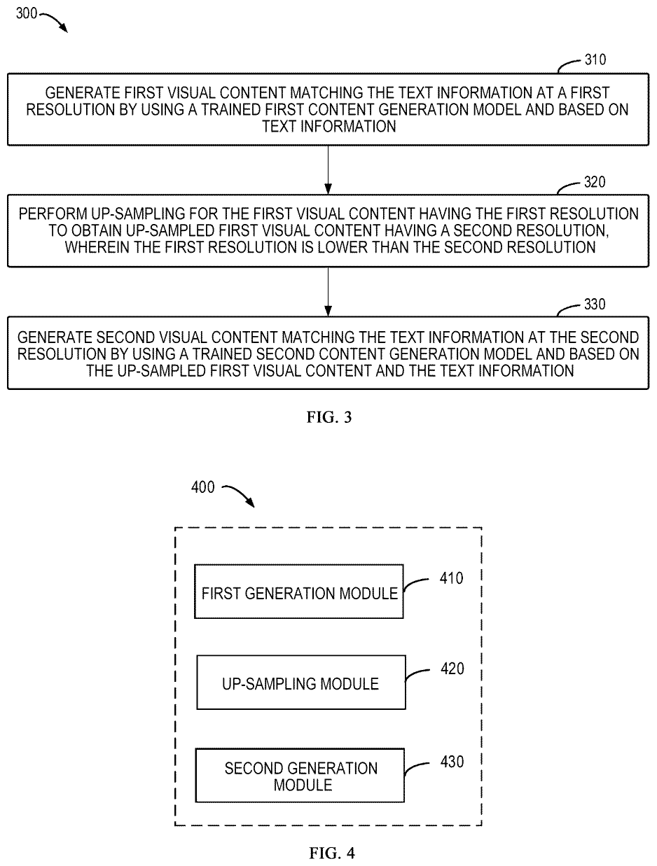

FIG. 3 shows a flowchart of a method 300 for visual generation according to some embodiments of the present disclosure. The method 300 may be implemented at the computing device 110 of FIG. 1. The method 300 will be described with reference to the environment 100 of FIG. 1.

At block 310, first visual content matching text information at a first resolution is generated by using a trained first content generation model and based on the text information.

At block 320, the first visual content having the first resolution is performed up-sampling to obtain up-sampled first visual content having a second resolution, where the first resolution is lower than the second resolution.

At block 330, second visual content matching the text information at the second resolution is generated by using a trained second content generation model and based on the up-sampled first visual content and the text information.

In some embodiments, the first visual content is a first video, and the second visual content is a second video, where generating the first visual content includes: generating the first video at the first resolution and a first frame rate by using the first content generation model and based on the text information; and where generating the second visual content includes: generating the second video at the second resolution and a second frame rate by using the second content generation model and based on up-sampled first video and the text information, where the first frame rate is lower than the second frame rate.

In some embodiments, the first content generation model is constructed based on a first diffusion model, and the second content generation model is constructed based on a second diffusion model.

In some embodiments, generating the second visual content includes: performing a plurality of inference steps of the second content generation model iteratively, where a given inference step in the plurality of inference steps includes: generating differential visual content by using the second content generation model and based on input visual content for the given inference step, the text information, and a weighting parameter for the given inference step, where the input visual content is initialized to the up-sampled first visual content in the plurality of inference steps; determining predicted visual content for the given inference step based on a combination of the differential visual content and the input visual content for the given inference step; determining the predicted visual content for the given inference step as input visual content for a next inference step; and updating the weighting parameter to obtain input visual content for the next inference step; and obtaining, as the second visual content, predicted visual content obtained after inference with the plurality of inference steps.

In some embodiments, the second content generation model is trained by: obtaining a sample pair including first sample visual content having the first resolution and second sample visual content having the second resolution; determining differential visual content between the second sample visual content and the first sample visual content; determining, for a given inference step in the plurality of inference steps, a first weight for the first sample visual content and a second weight for the second sample visual content; weighting and aggregating the first sample visual content and the second sample visual content respectively based on the first weight and the second weight, to obtain input visual content for the given inference step; determining predicted visual content for the given inference step by using a second content generation model being trained and based on the input visual content; and updating the second content generation model based on a difference between the differential visual content and the predicted visual content.

In some embodiments, the first content generation model is trained based on a plurality of sample texts and a plurality of sample videos having the first resolution, and where a motion score of a first sample video in the plurality of sample videos is below a predetermined motion threshold, and a sample text corresponding to the first sample video includes a motion indicator and a text description for the first sample video, the motion indicator indicating that the first sample video is a low-motion video.

In some embodiments, the second content generation model is trained based on a plurality of sample pairs, each sample pair including first sample visual content having the first resolution and second sample visual content having the second resolution, the first sample visual content is generated by: performing a pixel space down-grading operation for the second sample visual content to obtain second down-graded sample visual content having the first resolution, the pixel space down-grading operation including at least a size compression operation and a blurring operation; and applying a noise signal to the second down-graded sample visual content having the first resolution, to obtain the first sample visual content.

In some embodiments, where applying the noise signal to the second down-graded sample visual content having the first resolution, to obtain the first sample visual content includes: encoding the second down-graded sample visual content into a visual feature representation; obtaining a noise-added visual content feature representation by applying a noise signal to the visual feature representation; and decoding the noise-added visual feature representation to generate the first sample visual content.

In some embodiments, the plurality of sample pairs includes: a first sample pair including a first sample image having the first resolution and a second sample image having the second resolution; and a second sample pair including a first sample video having the first resolution and a second sample video having the second resolution.

Embodiments of the present disclosure further provide a corresponding apparatus for implementing the foregoing method or process. FIG. 4 shows an example structural block diagram of an apparatus 400 for visual generation according to some embodiments of the present disclosure. The apparatus 400 may be implemented as or included in the electronic device 110. Each module/component in the apparatus 400 may be implemented by hardware, software, firmware, or any combination thereof.

As shown in FIG. 4, the apparatus 400 includes a first generation module 410 configured to generate first visual content matching the text information at a first resolution by using a trained first content generation model and based on text information; an up-sampling module 420 configured to perform up-sampling for the first visual content having the first resolution to obtain up-sampled first visual content having a second resolution, where the first resolution is lower than the second resolution; and a second generation module 430 configured to generate second visual content matching the text information at the second resolution by using a trained second content generation model and based on the up-sampled first visual content and the text information.

In some embodiments, the first visual content is a first video, and the second visual content is a second video, the first generation module 410 is further configured to generate the first video at the first resolution and a first frame rate by using the first content generation model and based on the text information; and the second generation module 430 is further configured to generate the second video at the second resolution and a second frame rate by using the second content generation model and based on up-sampled first video and the text information, where the first frame rate is lower than the second frame rate.

In some embodiments, the first content generation model is constructed based on a first diffusion model, and the second content generation model is constructed based on a second diffusion model.

In some embodiments, the second generation module 430 is further configured to perform a plurality of inference steps of the second content generation model iteratively, where a given inference step in the plurality of inference steps includes: generating differential visual content by using the second content generation model and based on input visual content for the given inference step, the text information, and a weighting parameter for the given inference step, where the input visual content is initialized to the up-sampled first visual content in the plurality of inference steps; determining predicted visual content for the given inference step based on a combination of the differential visual content and the input visual content for the given inference step; determining the predicted visual content for the given inference step as input visual content for a next inference step; and updating the weighting parameter to obtain input visual content for the next inference step; and obtaining, as the second visual content, predicted visual content obtained after inference with the plurality of inference steps.

In some embodiments, the apparatus 400 further includes a second content generation model training module configured to obtain a sample pair including first sample visual content having the first resolution and second sample visual content having the second resolution; determine differential visual content between the second sample visual content and the first sample visual content; determine, for a given inference step in a plurality of inference steps, a first weight for the first sample visual content and a second weight for the second sample visual content; weight and aggregate the first sample visual content and the second sample visual content respectively based on the first weight and the second weight, to obtain input visual content for the given inference step; determine predicted visual content for the given inference step by using a second content generation model being trained and based on the input visual content; and update the second content generation model based on a difference between the differential visual content and the predicted visual content.

In some embodiments, the apparatus 400 further includes a first content generation model training module configured to obtain a plurality of sample texts and a plurality of sample videos having the first resolution, where a motion score of a first sample video in the plurality of sample videos is lower than a predetermined motion threshold, and a sample text corresponding to the first sample video includes a motion indicator and a text description for the first sample video, the motion indicator indicating that the first sample video is a low-motion video.

In some embodiments, the second content generation model is trained based on a plurality of sample pairs, each sample pair includes first sample visual content having the first resolution and second sample visual content having the second resolution, where the first sample visual content is generated by: performing a pixel space down-grading operation for the second sample visual content to obtain second down-graded sample visual content having the first resolution, the pixel space down-grading operation including at least a size compression operation and a blurring operation; and applying a noise signal to the second down-graded sample visual content having the first resolution, to obtain the first sample visual content.

In some embodiments, the apparatus 400 is further configured to encode the second down-graded sample visual content into a visual feature representation; obtain a noise-added visual content feature representation by applying a noise signal to the visual feature representation; and decode the noise-added visual feature representation to generate the first sample visual content.

In some embodiments, the plurality of sample pairs include a first sample pair including a first sample image having the first resolution and a second sample image having the second resolution; and a second sample pair including a first sample video having the first resolution and a second sample video having the second resolution.

The units and/or modules included in the apparatus 400 may be implemented in various manners, including software, hardware, firmware, or any combination thereof. In some embodiments, one or more units and/or modules may be implemented using software and/or firmware, for example machine-executable instructions stored on a storage medium. In addition to machine-executable instructions or as an alternative, some or all units and/or modules in the apparatus 400 may be implemented at least partially by one or more hardware logic components. As an example, rather than a limitation, example types of hardware logic components that may be used include field programmable gate array (FPGA), application specific integrated circuit (ASIC), application specific standard (ASSP), system on chip (SOC), complex programmable logic device (CPLD), etc.

It should be understood that one or more steps of the above method may be performed by a suitable electronic device or a combination of electronic devices. Such an electronic device or a combination of electronic devices may include, for example, the computing device 110 in FIG. 1.

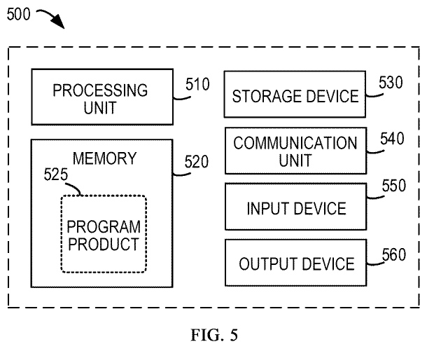

FIG. 5 shows a block diagram of an electronic device 500 in which one or more embodiments of the present disclosure may be implemented. It should be understood that the electronic device 500 shown in FIG. 5 is only example, without suggesting any limitation to the functions and scope of the embodiments described herein. The electronic device 500 shown in FIG. 5 may be used to implement the electronic device 110 in FIG. 1 or the apparatus 400 in FIG. 4.

As shown in FIG. 5, the electronic device 500 is in the form of a general electronic device. The components of the electronic device 500 may include, but are not limited to, one or more processors or processing units 510, a memory 520, a storage device 530, one or more communication units 540, one or more input devices 550, and one or more output devices 560. The processing unit 510 may be an actual or virtual processor, and may perform various processing based on a program stored in the memory 520. In a multi-processor system, a plurality of processing units perform computer executable instructions in parallel to improve the parallel processing capability of the electronic device 500.

The electronic device 500 typically includes multiple computer storage medium. Such medium may be any available medium accessible by the electronic device 500, including but not limited to volatile and non-volatile medium, removable and non-removable medium. The memory 520 may be volatile memory (for example, a register, cache, random access memory (RAM)), non-volatile memory (such as a read-only memory (ROM), electrically erasable programmable read-only memory (EEPROM), flash memory), or any combination thereof. The storage device 530 may be any removable or non-removable medium, and may include a machine-readable medium such as a flash drive, a disk, or any other medium, which may be used to store information and/or data and may be accessed within the electronic device 500.

The electronic device 500 may further include additional removable/non-removable, volatile/non-volatile memory medium. Although not shown in FIG. 5, a disk drive for reading from or writing to a removable, non-volatile disk (such as a “floppy disk”), and an optical disk drive for reading from or writing to a removable, non-volatile optical disk may be provided. In these cases, each drive may be connected to the bus (not shown) by one or more data medium interfaces. The memory 520 may include a computer program product 525 having one or more program modules configured to perform various methods or acts of the various embodiments of the present disclosure.

The communication unit 540 enables communication with other electronic devices through the communication medium. Additionally, the functions of the components of the electronic device 500 may be implemented in a single computing cluster or multiple computing machines, which may communicate through communication connections. Therefore, the electronic device 500 may use a logical connection with one or more other servers, a network personal computer (PC), or another network node to operate in a networked environment.

The input device 550 may be one or more input devices, such as a mouse, a keyboard, a tracking ball, etc. The output device 560 may be one or more output devices, such as a display, a speaker, a printer, etc. The electronic device 500 may further communicate with one or more external devices (not shown) as needed through the communication unit 540, the external device being such as a storage device, a display device, etc., communicate with one or more devices that enable the user to interact with the electronic device 500, or communicate with any device (such as a network card, a modem, etc.) that enables the electronic device 500 to communicate with one or more other electronic devices. Such communication may be performed via input/output (I/O) interfaces (not shown).

According to an example implementation of the present disclosure, a computer-readable storage medium is provided, having computer-executable instructions stored thereon, where the computer-executable instructions are executed by a processor to implement the method described above. According to an example implementation of the present disclosure, there is further provided a computer program product tangibly stored on a non-transitory computer-readable medium and including computer-executable instructions, which are executed by a processor to implement the method described above.

Various aspects of the present disclosure are described herein with reference to the flowcharts and/or block diagrams of the method, apparatus, device, and computer program product implemented according to the present disclosure. It should be understood that each block of the flowcharts and/or block diagrams, and combinations of blocks in the flowcharts and/or block diagrams, may be implemented by computer-readable program instructions.

These computer-readable program instructions may be provided to a processing unit of a general-purpose computer, a special-purpose computer, or other programmable data processing apparatus to produce a machine, such that when the instructions are executed by the processing unit of the computer or other programmable data processing apparatus, the apparatus for implementing the functions/acts specified in one or more blocks of the flowcharts and/or block diagrams is produced. These computer-readable program instructions may also be stored in a computer-readable storage medium, which instructions cause the computer, the programmable data processing apparatus, and/or other devices to work in a specific manner, such that the computer-readable medium having the instructions stored thereon includes a manufactured product, which includes instructions for implementing various aspects of the functions/acts specified in one or more blocks of the flowcharts and/or block diagrams.

The computer-readable program instructions may be loaded onto a computer, another programmable data processing apparatus, or other devices, so that a series of operations and steps are performed on the computer, other programmable data processing apparatus, or other devices to produce a computer-implemented process, such that the instructions executed on the computer, other programmable data processing apparatus, or other devices implement the functions/acts specified in one or more blocks of the flowcharts and/or block diagrams.

The flowcharts and block diagrams in the figures show the possibly implemented architectures, functions, and operations of the system, method, and computer program product according to various implementations of the present disclosure. In this regard, each block in the flowchart or block diagram may represent a module, program segment, or part of an instruction, which includes one or more executable instructions for implementing the specified logical functions. In some updated implementations, the functions marked in the blocks may also occur in an order different from that marked in the drawings. For example, two consecutive blocks may actually be performed substantially in parallel, or they may sometimes be performed in the reverse order, depending on the functions involved. It should also be noted that each block in the block diagrams and/or flowcharts, and combinations of blocks in the block diagrams and/or flowcharts, may be implemented in a special-purpose hardware-based system that perform the specified functions or acts, or may be implemented in a combination of special-purpose hardware and computer instructions.

Various implementations of the present disclosure have been described above, and the above description is illustrative, not exhaustive, and is not limited to the disclosed implementations. Many modifications and variations will be apparent to those of ordinary skill in the art without departing from the scope and spirit of the described implementations. The choice of terms used herein is intended to best explain the principles of the implementations, practical applications, or improvements to the technology in the market, or to enable other persons of ordinary skill in the art to understand the various implementations disclosed herein.

1. A method for visual generation, comprising:
generating first visual content matching the text information at a first resolution by using a trained first content generation model and based on text information;
performing up-sampling for the first visual content having the first resolution to obtain up-sampled first visual content having a second resolution, wherein the first resolution is lower than the second resolution; and
generating second visual content matching the text information at the second resolution by using a trained second content generation model and based on the up-sampled first visual content and the text information.

2. The method of claim 1, wherein the first visual content is a first video, and the second visual content is a second video, wherein generating the first visual content comprises:
generating the first video at the first resolution and a first frame rate by using the first content generation model and based on the text information; and
wherein generating the second visual content comprises:
generating the second video at the second resolution and a second frame rate by using the second content generation model and based on up-sampled first video and the text information, wherein the first frame rate is lower than the second frame rate.

3. The method of claim 1, wherein the first content generation model is constructed based on a first diffusion model, and the second content generation model is constructed based on a second diffusion model.

4. The method of claim 1, wherein generating the second visual content comprises:
performing a plurality of inference steps of the second content generation model iteratively, wherein a given inference step in the plurality of inference steps comprises:
generating differential visual content by using the second content generation model and based on input visual content for the given inference step, the text information, and a weighting parameter for the given inference step, wherein the input visual content is initialized to the up-sampled first visual content in the plurality of inference steps;
determining predicted visual content for the given inference step based on a combination of the differential visual content and the input visual content for the given inference step;
determining the predicted visual content for the given inference step as input visual content for a next inference step; and
updating the weighting parameter to obtain input visual content for the next inference step;
obtaining, as the second visual content, predicted visual content obtained after inference with the plurality of inference steps.

5. The method of claim 1, wherein the second content generation model is trained by:
obtaining a sample pair comprising first sample visual content having the first resolution and second sample visual content having the second resolution;
determining differential visual content between the second sample visual content and the first sample visual content;
for a given inference step in a plurality of inference steps,
determining a first weight for the first sample visual content and a second weight for the second sample visual content;
weighting and aggregating the first sample visual content and the second sample visual content respectively based on the first weight and the second weight, to obtain input visual content for the given inference step;
determining predicted visual content for the given inference step by using a second content generation model being trained and based on the input visual content; and
updating the second content generation model based on a difference between the differential visual content and the predicted visual content.

6. The method of claim 1, wherein the first content generation model is trained based on a plurality of sample texts and a plurality of sample videos having the first resolution, and
wherein a motion score of a first sample video in the plurality of sample videos is below a predetermined motion threshold, and a sample text corresponding to the first sample video comprises a motion indicator and a text description for the first sample video, the motion indicator indicating that the first sample video is a low-motion video.

7. The method of claim 1, wherein the second content generation model is trained based on a plurality of sample pairs, each sample pair comprising first sample visual content having the first resolution and second sample visual content having the second resolution, wherein the first sample visual content is generated by:
performing a pixel space down-grading operation for the second sample visual content to obtain second down-graded sample visual content having the first resolution, the pixel space down-grading operation comprising at least a size compression operation and a blurring operation; and
applying a noise signal to the second down-graded sample visual content having the first resolution, to obtain the first sample visual content.

8. The method of claim 7, wherein applying the noise signal to the second down-graded sample visual content having the first resolution, to obtain the first sample visual content comprises:
encoding the second down-graded sample visual content into a visual feature representation;
obtaining a noise-added visual content feature representation by applying a noise signal to the visual feature representation; and
decoding the noise-added visual feature representation to generate the first sample visual content.

9. The method of claim 7, wherein the plurality of sample pairs comprises:
a first sample pair comprising a first sample image having the first resolution and a second sample image having the second resolution; and
a second sample pair comprising a first sample video having the first resolution and a second sample video having the second resolution.

10. An electronic device, comprising:
at least one processor; and
at least one memory, the at least one memory being coupled to the at least one processor and storing instructions executable by the at least one processor, the instructions, when executed by the at least one processor, causing the device to perform acts comprising:
generating first visual content matching the text information at a first resolution by using a trained first content generation model and based on text information;
performing up-sampling for the first visual content having the first resolution to obtain up-sampled first visual content having a second resolution, wherein the first resolution is lower than the second resolution; and
generating second visual content matching the text information at the second resolution by using a trained second content generation model and based on the up-sampled first visual content and the text information.

11. The electronic device of claim 10, wherein the first visual content is a first video, and the second visual content is a second video, wherein generating the first visual content comprises:
generating the first video at the first resolution and a first frame rate by using the first content generation model and based on the text information; and
wherein generating the second visual content comprises:
generating the second video at the second resolution and a second frame rate by using the second content generation model and based on up-sampled first video and the text information, wherein the first frame rate is lower than the second frame rate.

12. The electronic device of claim 10, wherein the first content generation model is constructed based on a first diffusion model, and the second content generation model is constructed based on a second diffusion model.

13. The electronic device of claim 10, wherein generating the second visual content comprises:
performing a plurality of inference steps of the second content generation model iteratively, wherein a given inference step in the plurality of inference steps comprises:
generating differential visual content by using the second content generation model and based on input visual content for the given inference step, the text information, and a weighting parameter for the given inference step, wherein the input visual content is initialized to the up-sampled first visual content in the plurality of inference steps;
determining predicted visual content for the given inference step based on a combination of the differential visual content and the input visual content for the given inference step;
determining the predicted visual content for the given inference step as input visual content for a next inference step; and
updating the weighting parameter to obtain input visual content for the next inference step;
obtaining, as the second visual content, predicted visual content obtained after inference with the plurality of inference steps.

14. The electronic device of claim 10, wherein the second content generation model is trained by:
obtaining a sample pair comprising first sample visual content having the first resolution and second sample visual content having the second resolution;
determining differential visual content between the second sample visual content and the first sample visual content;
for a given inference step in a plurality of inference steps,
determining a first weight for the first sample visual content and a second weight for the second sample visual content;
weighting and aggregating the first sample visual content and the second sample visual content respectively based on the first weight and the second weight, to obtain input visual content for the given inference step;
determining predicted visual content for the given inference step by using a second content generation model being trained and based on the input visual content; and
updating the second content generation model based on a difference between the differential visual content and the predicted visual content.

15. The electronic device of claim 10, wherein the first content generation model is trained based on a plurality of sample texts and a plurality of sample videos having the first resolution, and
wherein a motion score of a first sample video in the plurality of sample videos is below a predetermined motion threshold, and a sample text corresponding to the first sample video comprises a motion indicator and a text description for the first sample video, the motion indicator indicating that the first sample video is a low-motion video.

16. The electronic device of claim 10, wherein the second content generation model is trained based on a plurality of sample pairs, each sample pair comprising first sample visual content having the first resolution and second sample visual content having the second resolution, wherein the first sample visual content is generated by:
performing a pixel space down-grading operation for the second sample visual content to obtain second down-graded sample visual content having the first resolution, the pixel space down-grading operation comprising at least a size compression operation and a blurring operation; and
applying a noise signal to the second down-graded sample visual content having the first resolution, to obtain the first sample visual content.

17. The electronic device of claim 16, wherein applying the noise signal to the second down-graded sample visual content having the first resolution, to obtain the first sample visual content comprises:
encoding the second down-graded sample visual content into a visual feature representation;
obtaining a noise-added visual content feature representation by applying a noise signal to the visual feature representation; and
decoding the noise-added visual feature representation to generate the first sample visual content.

18. The electronic device of claim 16, wherein the plurality of sample pairs comprises:
a first sample pair comprising a first sample image having the first resolution and a second sample image having the second resolution; and
a second sample pair comprising a first sample video having the first resolution and a second sample video having the second resolution.

19. A non-transitory computer-readable storage medium having a computer program stored thereon, the computer program, when executed by a processor, implementing acts comprising:
generating first visual content matching the text information at a first resolution by using a trained first content generation model and based on text information;
performing up-sampling for the first visual content having the first resolution to obtain up-sampled first visual content having a second resolution, wherein the first resolution is lower than the second resolution; and
generating second visual content matching the text information at the second resolution by using a trained second content generation model and based on the up-sampled first visual content and the text information.

20. The non-transitory computer-readable storage medium of claim 19, wherein the first visual content is a first video, and the second visual content is a second video, wherein generating the first visual content comprises:
generating the first video at the first resolution and a first frame rate by using the first content generation model and based on the text information; and
wherein generating the second visual content comprises:
generating the second video at the second resolution and a second frame rate by using the second content generation model and based on up-sampled first video and the text information, wherein the first frame rate is lower than the second frame rate.
